(19) United States
(12) Patent Application Publication
(10) Pub. No.: US 2019/0272717 A1
(43) Pub. Date: Sep. 5, 2019

(54) SALES REGISTRATION APPARATUS

(71) Applicant: TOSHIBA TEC KABUSHIKI KAISHA, Tokyo (JP)

(72) Inventor: Shinsuke YAJIMA, Mishima Shizuoka (JP)

(21) Appl. No.: 16/291,259

(22) Filed: Mar. 4, 2019

(30) Foreign Application Priority Data
Mar. 5, 2018 (JP) 2018-038887

(51) Int. Cl. G07G 1/12; G07G 1/00

(52) U.S. Cl. CPC G07G 1/12; G07G 1/0045; G07G 1/0018

(57) ABSTRACT

A sales registration apparatus comprises a main body that can be placed on or mounted to an upper surface of a checkout counter. A reader is housed in the main body between a first side surface and a second side surface to read information from a commodity positioned on a front side of the main body. A display section is attached to an upper end of the main body. A first supporting section is on the first side surface of the main body. A second supporting section is on the second side surface of the main body. A gap for wiring is formed between the first supporting section and the main body. Another gap for wiring is formed between the second supporting section and the main body.

### CROSS-REFERENCE TO RELATED APPLICATION

This application is based upon and claims the benefit of priority from Japanese Patent Application No. 2018-038887, filed in Mar. 5, 2018, the entire contents of which are incorporated herein by reference.

### FIELD

Embodiments described herein relate generally to a sales registration apparatus.

### BACKGROUND

A checkout system of a known type uses a sales registration apparatus to perform registration of items in a sales transaction for a customer and a separate accounting apparatus for settlement processing of the sales transaction for the customer. In such a checkout system, a configuration in which a plurality of store clerks divide the labor of commodity registration and transaction settlement (a two-person work type) and a configuration in which the customer performs settlement (a semi-self service type) can be adopted.

In the checkout system, a sales registration apparatus of a type called a vertical scanner is often used for space saving and the like. In such a sales registration apparatus, there is known a configuration in which a reading device and other components are housed in a main body section mounted on a checkout counter and a display device is provided above the main body section.

In recent years, there has been a trend toward increased display screen sizes. A configuration has also been developed in which the display device incorporates a control unit and a power supply unit for the entire sales registration apparatus. In such a case, the total weight of the display device increases. Thus, existing sales registration apparatuses of this type may tend to shake, wobble, or the like occur because of insufficient strength of the main body section to handle the increased weights. It is likely that a larger display device cannot be stably held by an existing sales registration apparatus. Furthermore, when the display device includes the control unit and the power supply unit, several wires are concentrated at the display device. However, in the configurations of the existing sales registration apparatuses, a path for wires and cables leading to the display device for additional device components was not particularly considered. Therefore, it is likely that wiring work to incorporate a new display incorporating a control unit and power supply will be complicated.

### DESCRIPTION OF THE DRAWINGS

FIG. 1 depicts a checkout system according to an embodiment.

FIG. 2 depicts a sales registration apparatus viewed from the front side.

FIG. 3 depicts a sales registration apparatus viewed from the back side.

FIG. 4 depicts an internal configuration of a housing.

FIG. 5 depicts an internal configuration of a housing viewed from the front side.

FIG. 6 depicts a cross section of a housing taken at a position A1 illustrated in FIG. 4.

### DETAILED DESCRIPTION

According to one embodiment, a sales registration apparatus comprises a main body to be placed on an upper surface of a checkout counter or the like. A reader is housed in the main body between a first side surface and a second side surface. The reader is configured to read information from a commodity positioned on a front side of the main body. A display section is attached to an upper end of the main body. A first supporting section is on the first side surface of the main body. A second supporting section is on the second side surface of the main body. A first gap for wiring is formed between the first supporting section and the main body. A second gap for wiring is formed between the second supporting section and the main body.

An example sales registration apparatus according to an embodiment is explained in detail below with reference to the accompanying drawings. In the example explained below, a sales registration apparatus to be used in checkout systems of a two-person work type or a semi-self service type, is explained. However, the present disclosure is not limited to this example.

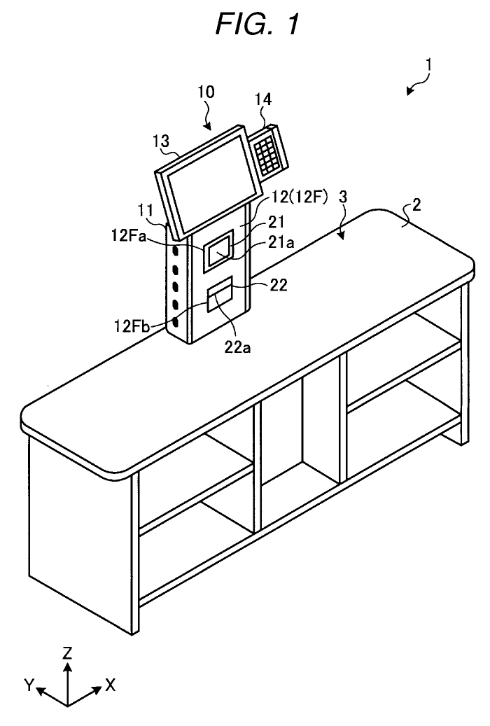

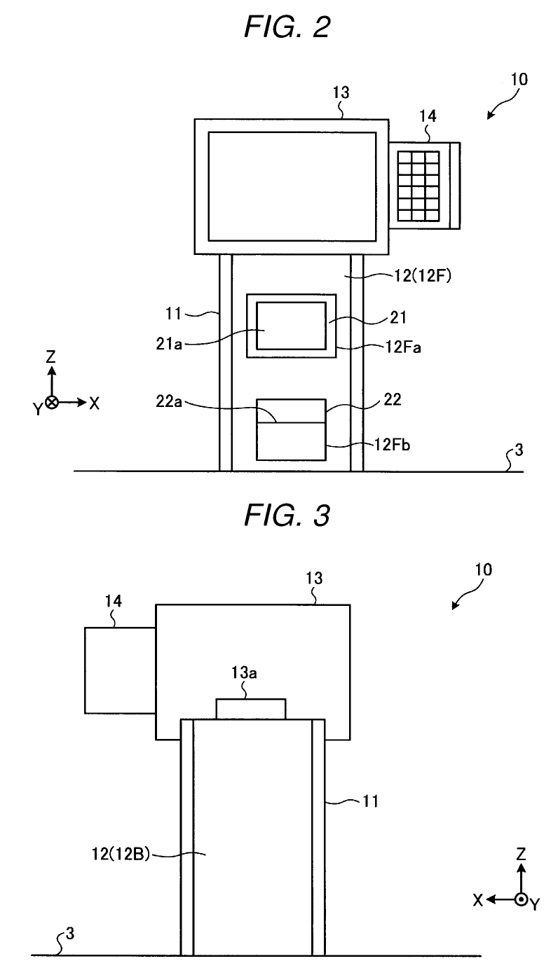

FIG. 1 is a perspective view illustrating an example of a checkout system 1 according to an embodiment. FIG. 2 is a view of a sales registration apparatus 10 illustrated in FIG. 1 viewed from the front side (an operator side). FIG. 3 is a view of the sales registration apparatus 10 illustrated in FIG. 1 viewed from the back side (a customer side).

The checkout system 1 includes a checkout counter 2 having a laterally long table shape. A flat loading surface 3 is on the upper surface of the checkout counter 2. A shopping basket or the like can be placed on the loading surface 3.

The sales registration apparatus 10 is positioned in a substantially centered position along the long direction of the checkout counter 2. The sales registration apparatus 10 is a vertical-type scanner apparatus, also referred to as a vertical scanner. The sales registration apparatus 10 is located on the far side of the loading surface as viewed from an operator. The sales registration apparatus 10 is communicably connected to an external apparatus such as a settlement terminal.

The sales registration apparatus 10 is comprises a housing 11 disposed or mounted on the loading surface 3. The housing 11 houses various devices or components related to the functions of the sales registration apparatus 10. The housing 11 includes, for example, a reading section 21 and a printer section 22 on the inside.

The reading section 21 includes a reading device that reads, via a reading window 21a, information concerning a commodity to be registered, such as a code symbol attached to the commodity or another characteristic of the commodity. The reading section 21 includes a light that emits reading light through the reading window 21a, an image sensor that receives reflected reading light, and a decoder that executes decode processing on an output signal of the image sensor.

The printer section 22 is a printing device that prints a receipt. The printer section 22 includes a paper storing section for storing paper, a conveying section that conveys the paper stored in the paper storing section to a paper discharge port 22a, and a printer that performs printing on the paper.

Panel sections 12 (12F and 12B) are detachably attached to the front surface and the back surface of the housing 11. The panel section 12 is formed of a plate-like member such as resin and covers the outer surface of the housing 11. In the panel section 12F attached to the front side of the housing 11, opening sections 12Fa and 12Fb are provided such that portions of the reading section 21 and the printer section 22 are exposed.

A display section 13 is attached to an upper part of the housing 11. The display section 13 comprises a display device including a display such as a liquid crystal display. The display section 13 projects beyond the front surface of the housing 11 toward the operator side of checkout counter 2. A front portion of the display section 13 is inclined. The display section 13 is used as a display for the operator (e.g., store clerk) of the sales registration apparatus 10. The display section 13 may have a touch panel configuration. The display section 13 may include a power supply unit for the sales registration apparatus 10 and a control unit for the sales registration apparatus 10. The control unit comprises a CPU (Central Processing Unit), a ROM (Read Only Memory), and a RAM (Random Access Memory).

An operation panel 14 is provided adjacent to the display section 13. In an example shown in FIG. 1, the operation panel 14 is provided on the right of the display section 13 when viewed from the operator. The operation panel 14 includes an input device such as a keypad.

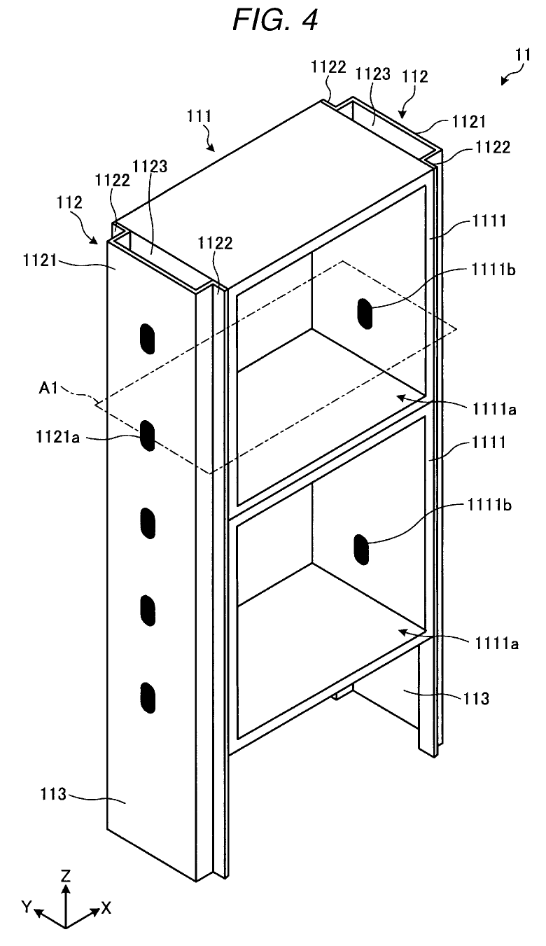

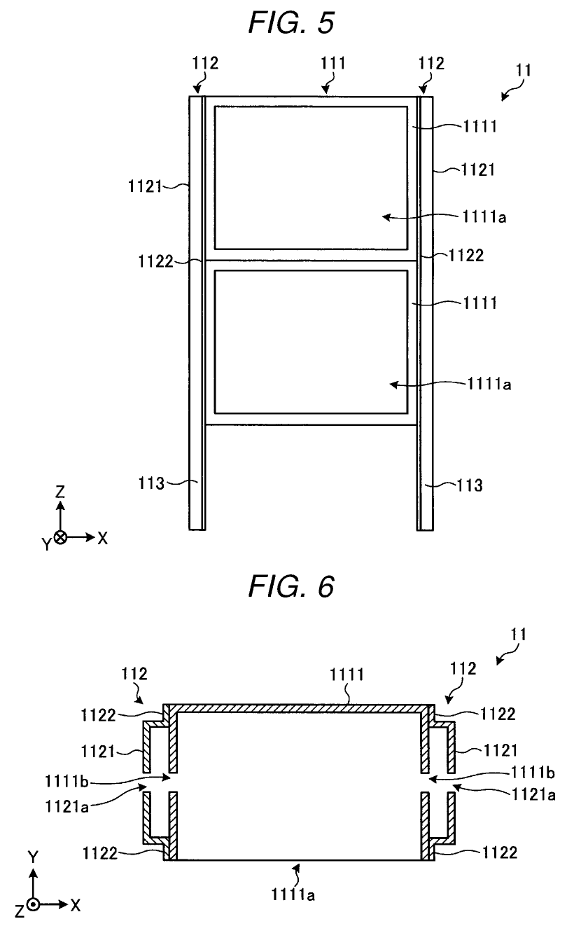

A through-hole, into which foot sections 113 (see FIGS. 4 and 5) of the housing 11 are inserted, is formed on the loading surface 3. By inserting the foot sections 113 of the housing 11 into the through-hole of the loading surface 3, the housing 11 is fixed (mounted) on the loading surface 3. The height of the sales registration apparatus 10 on the loading surface 3 is desirably set to approximately eye-level height of the operator.

The configuration of a sales registration apparatus 10 is not limited to the example explained above. For example, the sales registration apparatus 10 may include a display section for a customer (a customer display section) having a display screen directed to the back side of the sales registration apparatus 10. The customer display section can be attached to, for example, the back of the display section 13 or a position adjacent to the display section 13.

An internal configuration of the sales registration apparatus 10 (more particularly the housing 11) is explained with reference to FIGS. 4 to 6. FIG. 4 is a perspective view illustrating an example of the internal configuration of the housing 11 illustrated in FIG. 1. FIG. 5 is a view of the internal configuration of the housing 11 illustrated in FIG. 4 viewed from the front side. FIG. 6 is a diagram illustrating a cross section in a position A1 illustrated in FIG. 4. FIGS. 4 to 6 illustrate a state in which the panel sections 12, the display section 13, and the operation panel 14 have been removed from the sales registration apparatus 10.

As illustrated in FIGS. 4 to 6, the housing 11 includes a main body section 111 and supporting sections 112. The main body section 111 has a substantially box-like shape long in the height/vertical direction (Z direction)e. The main body section 111 is formed by at least two frame sections 1111 stacked in stages in the height direction.

The frame sections 1111 are formed by, for example, metal plates and have a substantially box-like shape. The frame sections 1111 are stacked on one another in the height direction. The stacked frame sections 1111 are joined by welding, screwing, or the like to form the main body section 111. In this way, the main body section 111 is configured as a plurality of blocks by the divisions of the frame sections 1111.

The frame sections 1111 include opening sections 1111a on the front side and form spaces capable of storing devices such as the reading section 21 and the printer section 22. Devices having outlets, ports, windows or the like on their front surfaces are housed in the frame sections 1111 such that these outlets, ports, windows or the like face outward from the front side of the sales registration apparatus 10. For example, the reading section 21 is housed with the reading window 21a pointing from the front side (see FIG. 1). The printer section 22 is housed with the paper discharge port 22a at the front side (see FIG. 1).

Housed devices are not limited to a reading section 21 and a printer section 22. For example, a control unit and a power supply unit of the sales registration apparatus 10 may be housed within frame sections 1111 in some examples. The frame sections 1111 may also house a peripheral device such as a card reader.

The devices housed in the frame sections 1111 may be fixed within the frame sections 1111 or may be set within a state in which the devices taken out from the frame sections 1111. In the latter case, the frame sections 1111 may include slide/pull mechanisms permitting the sliding of the housed devices into and out of the main body section 111 and a placement surface on which the devices are placed. With such a design, the operator can easily install electronic devices in the frame sections 1111 and remove the electronic devices housed in the frame sections 1111. For example, if the printer section 22 is housed in the frame section 1111, the operator generally must often access the printer section 22, for example, every time the operator replaces paper. By providing the slide mechanism in the frame section 1111, the operator can easily access the printer section 22 for such tasks. Therefore, it is possible to achieve improvement of user convenience.

Cable holes 1111b, which are through-holes, are provided on side surfaces of the frame sections 1111. The cable holes 1111b are holes for allowing passage of cables (signal lines, electric wires, etc.) for connecting the devices housed within the frame sections 1111 to other devices.

The individual sizes of the frame sections 1111 do not particularly matter so long as the devices to be housed can be fit into the frame sections 1111. In FIGS. 4 and 5, the dimensions of each frame section 1111 are the same but the present disclosure is not limited to this. However, the width dimensions (X direction) for each frame section 111, as well as the depth dimensions (Y direction), may be desirably equal because the frame sections 1111 are to be stacked one on the other in the height direction (Z direction). The height (Z direction) of the frame sections 1111 may be the same for each frame sections 1111 or may be different according to the sizes of devices intended to be housed in the particular frame section 1111. Likewise, the number of stages (stacking number) of the frame sections 1111 to be stacked is not limited to two and may be three or more.

Once devices are housed in the frame sections 1111, the panel section 12F is attached to the front side of the main body section 111. Consequently, the opening sections 1111a are covered by the panel section 12F (see FIGS. 1 and 2). As explained above, the portions of the devices housed in the frame sections 1111 can be exposed by the opening sections 12Fa and 12Fb provided in the panel section 12F. Consequently, the operator can access the housed devices even after the panel section 12F is attached.

The supporting sections 112 are attached to each side surfaces of the main body section 111. The supporting sections 112 are columnar members having a horseshoe-shaped (also referred to as C-shaped in some contexts) in cross sections crossing the height direction of the main body section 111. The supporting sections 112 are formed by, for example, a metal plate. The supporting sections 112 support the main body section 111 from both side surfaces.

The supporting sections 112 include side surface sections 1121 substantially C-shaped in cross sections. Extended sections 1122 extended from both edges (front side edge and backside edge) of the side surface sections 1121 toward the outer side. The side surface sections 1121 form the side surfaces (left/right sides) of the housing 11 when the supporting sections 112 are attached to the main body section 111. The extended sections 1122 are parts that are used to join the main body section 111 to the supporting sections 112. The width (Y direction) of the supporting sections 112 is substantially equal to the depth (Y direction) of the main body section 111. The length (Z direction) of the supporting sections 112 is selected to be greater than the height dimension (Z direction) of the main body section 111.

The supporting sections 112 are fixed (joined) to the side surfaces of the main body section 111 by welding, screwing, or the like. Specifically, the upper ends of the supporting sections 112 are aligned with the upper surface of the main body section 111. The extended sections 1122 provided at both edges of the side surface sections 1121 are joined to the side surfaces of the main body section 111 along the height dimension of the main body section 111. That is, the supporting sections 112 are attached such that recessed sides of C-shaped step surfaces are contacting the side surfaces of the main body section 111.

Lower end portions of the supporting sections 112, that is, portions of the supporting sections 112 projecting from the lower surface of the main body section 111 are utilized as foot sections 113 of the housing 11. The foot sections 113 are eventually inserted into a through-hole in the loading surface 3. Consequently, the supporting sections 112 can be fixed to the loading surface 3 (or more broadly the checkout counter 2).

By integrating (joining) the main body section 111 and the supporting sections 112, gaps 1123 are formed along the height direction of the main body section 111 between the side surfaces of the main body section 111 and the side surface sections 1121. Each gap 1123 can be used as a wiring path. The gaps 1123 are connected to the cable holes 1111b on the side surfaces of the main body section 111. Consequently, wiring between different frame sections 1111 and wiring between a frame section 1111 and the display section 13 can be provided via the gaps 1123.

Guide holes 1121a are through-holes provided in the side surface sections 1121 of the supporting section 112. The guide holes 1121a are sized for enabling insertion of a finger, a cable, and the like and communicate with the gap 1123. A finger or the like can be inserted into the guide hole 1121a for drawing a wire or cable through or from the gap 1123. Consequently, in the sales registration apparatus 10, wiring can be easily performed via the gap 1123. Therefore, it is possible to achieve efficiency in wiring work.

The cable holes 1111b in the frame section 1111 and the guide holes 1121a in the supporting sections 112 are desirably set to be in opposed positions after installation as illustrated in FIG. 6. By setting the cable holes 1111b and the guide holes 1121a to be opposed to each other, a cable can be easily passed between the inside and the outside of the housing 11. Therefore, it is possible to achieve efficiency in wiring work.

An element other than the guide holes 1121a may be provided in or on the side surface sections 1121. For example, if a cover (e.g., a panel section 12) is to be attached to the side surface of the housing 11, the side surface section 1121 may include an attachment point or structure for attaching the panel section 12. If a shelf plate (also referred to as an arm section in some contexts) is to extends in the horizontal direction from the side surface of the housing 11, then the side surface section 1121 may include an attachment point or structure for attaching the shelf plate.

The display section 13 is attached to the upper surface of the main body section 111 (see FIGS. 1 to 3). Specifically, the display section 13 is attached to the upper surface of the main body section 111 using a holder 13a (see FIG. 3) including a tilt mechanism for screen angle adjustments. The operation panel 14 is attached to one side (edge) of the display section 13.

In recent years, increases in the size of the display screen has been the trend. The weight of the display section 13 also tends to increase in this case. As explained above, a configuration in which the display section 13 also includes a control unit and a power supply unit for the entire sales registration apparatus 10 is also possible. In such a configuration, weight of the display section 13 increases as compared with a configuration in which a control unit and a power supply unit are not mounted inside the display section 13.

However, in the sales registration apparatus 10, the main body section 111 is supported from both the side surfaces by the supporting sections 112. Therefore, it is possible to improve rigidity (strength) of the main body section 111. Consequently, in the sales registration apparatus 10, occurrence of shakes, wobbles, and the like due to insufficient rigidity can be prevented. It is thus possible to stably hold a heavy display section 13, operation panel 14, and the like which are attached to an upper part of the main body section 111.

In the configuration of the display section 13 and the operation panel 14, the operation panel 14 is provided in a position well off the central axis of the sales registration apparatus 10, more particular off the centerline (Z-axis) of the housing 11. Therefore, when the operation panel 14 is pressed, a torque is applied to the housing 11 (more particularly, the main body section 111).

However, since the main body section 111 is supported from both the side surfaces by the supporting sections 112, rigidity (strength) against the torque forces can be improved. Consequently, shakes and wobbles due to pressing of the operation panel 14 can be prevented. Therefore, it is possible to improve operability and stability of the operation panel 14. Furthermore, thinning/narrowing of the main body section 111 can be achieved in view of the improvements in the rigidity (strength) of the main body section 111. Therefore, it is possible to secure a wider area on the loading surface 3 for other uses besides mounting the sales registration apparatus 10.

If the display section 13 includes the control unit and the power supply unit, several additional wires are concentrated at the display section 13. However, in the sales registration apparatus 10, the gaps 1123 between the supporting sections 112 and the main body section 111 function as the wiring paths. Therefore, it is possible to easily perform wiring between the frame sections 1111 and wiring between the frame sections 1111 and the display section 13 using the gaps 1123. In the sales registration apparatus 10, since a cable holes 1111b communicating with a gap 1123 is provided in each of the frame sections 1111, it is possible to easily perform wiring between the frame sections 1111 and the gaps 1123. Therefore, in the sales registration apparatus 10, it is possible to efficiently perform wiring work between devices included in the sales registration apparatus 10.

In the described example, the front side of the frame sections 1111 is open. However, in other examples the back side of the frame sections 1111 may be open instead or in addition to the front side. With this configuration, a device to be operated by the customer can be housed in the frame section 1111 with an interface (inlet/outlet port, window, screen, etc.) directed to the back side of the frame section 1111. Consequently, the customer can operate a device housed in the frame section 1111. In the panel section 12B attached to the back side of the housing 11, as in the panel section 12F, an opening for accessing a portion of a housed device can be provided.

In the example explained above, a plurality of frame sections 1111 are stacked in stages to form the main body section 111. However, the main body section 111 structure is not limited to this. For example, in the main body section 111, one or more shelf plates may be provided on the inside of a frame section 1111. In this case, the main body section 111 (more particularly the frame section 1111) can include a cable hole 1111b for each of interior space formed by presence of the shelf plate(s).

The cross-sectional shape of the supporting sections 112 is not limited to the example embodiment. The cross-sectional shape may be other shapes so long as gaps 1123 or an equivalent is formed between the supporting sections 112 and the main body section 111. For example, the cross sections of the supporting sections 112 (more particularly the side surface sections 1121) may be formed in a horseshoe-shape (a C shape or a U shape) other than the shape described for the example embodiment. In such a case, as shown in FIG. 4, the gaps 1123 can be formed between the supporting sections 112 (the side surface sections 1121) and the main body section 111 by attaching the supporting sections 112 (the side surface sections 1121) with recessed sides of the horseshoe-shaped cross sections opposed to the side surfaces of the main body section 111. The extended sections 1122 may be extended from the both end portions of the side surface sections 1121 toward the outer side or may be extended toward the inner side.

The supporting sections 112 may be a columnar (tubular) member such as a square pipe having a hollow region on the inside. In such a case, the cross-sectional shape of the supporting sections 112 may not particularly matter so long as the supporting sections 112 have a shape to which the main body section 111 can be attached and include through-holes communicating with the cable holes 1111b in positions substantially aligned to the cable holes 1111b. The supporting sections 112 include the guide holes 1121a and the like on the surface sides forming the side surfaces of the housing 11. Consequently, the gaps 1123 can be formed between the supporting sections 112 and the main body section 111 by hollow regions (recesses) in the supporting sections 112.

Panel sections functioning as cover members may be attached to the side surface sections 1121 of the supporting sections 112. The method of attaching the panel sections to the side surface sections 1121 does not particularly matter. For example, the panel sections may be attached using the guide holes 1121a of the side surface sections 1121 as a point of attachment.

While certain embodiments have been described, these embodiments have been presented by way of example only, and are not intended to limit the scope of the present disclosure. Indeed, the novel methods and systems described herein may be embodied in a variety of other forms; furthermore, various omissions, substitutions, and changes in the form of the methods and systems described herein may be made without departing from the spirit of the present disclosure. The accompanying claims and their equivalents are intended to cover such forms or modifications as would fall within the scope and spirit of the disclosure.

What is claimed is:

1. A sales registration apparatus, comprising:
a main body to be placed on an upper surface of a checkout counter;
a reader housed in the main body between a first side surface and a second side surface and configured to read information from a commodity positioned on a front side of the main body;
a display section attached to an upper end of the main body;
a first supporting section on the first side surface of the main body; and
a second supporting section on the second side surface of the main body, wherein
a first gap for wiring is formed between the first supporting section and the main body, and
a second gap for wiring is formed between the second supporting section and the main body.

2. The sales registration apparatus according to claim 1, wherein lower ends of the first and second supporting sections extend beyond a lower surface of the main body and are configured to be fixed to the checkout counter.

3. The sales registration apparatus according to claim 1, wherein the first and second supporting sections are each C-shaped in cross sections taken across a height direction of the main body.

4. The sales registration apparatus according to claim 3, wherein the first and second supporting sections have the C-shaped cross section for an entire length of the main body in the height direction of the main body.

5. The sales registration apparatus according to claim 3, wherein
each of the first and second supporting section includes edge portions extending parallel to a portion of the respective first or second side surface of the main body, and
the first and second supporting sections are attached to the respect first or second side surface of the main body at the edge portions of the first or second supporting section such that that the first and second gaps are respectively formed within a recess between a central portion of the C-shaped cross-section and the respective first or second side surfaces of the main body.

6. The sales registration apparatus according to claim 5, wherein the edge portions of the first and second supporting sections are welded to the main body.

7. The sales registration apparatus according to claim 5, wherein the edge portions of the first and second supporting section are screwed to the main body.

8. The sales registration apparatus according to claim 1, further comprising:
a first through hole in the first side surface of the main body and communicating with the first gap; and
a second through hole in the first supporting section and communicating with the first gap.

9. The sales registration apparatus according to claim 8, wherein the first and second through holes are substantially aligned with each other across the first gap.

10. The sales registration apparatus according to claim 1, further comprising:
a cable connected to the reader and passing through the first gap.

11. The sales registration apparatus according to claim 1, further comprising:
an operation panel attached to one edge of the display device.

12. The sales registration apparatus according to claim 1, further comprising:
a front panel including a reader window, the front panel being attached to the front side of the main body.

13. The sales registration apparatus according to claim 1, wherein the main body comprises substantially box-like sections stacked one on the other.

14. A checkout apparatus, comprising:
a checkout counter having an upper surface;
a sales registration device on the checkout counter, the sales registration device including:
a main body mounted to the upper surface of the checkout counter;
a reader housed in the main body between a first side surface and a second side surface and configured to read information from a commodity positioned on a front side of the main body;
a display section attached to an upper end of the main body; and
a first supporting section on the first side surface of the main body;
a second supporting section on the second side surface of the main body, wherein
a first gap for wiring is formed between the first supporting section and the main body, and
a second gap for wiring is formed between the second supporting section and the main body.

15. The checkout apparatus according to claim 14, wherein lower ends of the first and second supporting sections extend beyond a lower surface of the main body and are fixed to the checkout counter.

16. The checkout apparatus according to claim 14, wherein the first and second supporting sections are each C-shaped in cross sections taken across a height direction of the main body.

17. The checkout apparatus according to claim 14, further comprising:
a first through hole in the first side surface of the main body and communicating with the first gap; and
a second through hole in the first supporting section and communicating with the first gap, wherein
the first and second through holes are substantially aligned with each other across the first gap.

18. A vertical scanner, comprising:
a housing mounted to a checkout counter;
a reader housed in the housing and configured to read information of an item in a sales transaction; and
a display section including an operator screen facing an operator of the reader and an operation panel configured to receive operator inputs related to the sales transaction, wherein
the housing comprises:
a main body section in which the reader is disposed; and
a supporting section on a side surface of the main body section, and
a gap for wiring is formed between the supporting section and the main body section.

19. The vertical scanner according to claim 18, wherein the supporting section is C-shaped in cross sections taken across a height direction of the main body section.

20. The vertical scanner according to claim 18, further comprising:
a first through hole in the side surface of the main body section and communicating with the gap;
a second through hole in the supporting section and communicating with the gap; and
a cable connected to the display device and passing through the gap.
